(19) United States
(12) Patent Application Publication
(10) Pub. No.: US 2004/0209514 A1
(43) Pub. Date: Oct. 21, 2004

(54) Personal care device support

(76) Inventors: Han Leng Marshall Yoe, Kowloon (HK); Samantha Dreimann, Lake Forest, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/218,923

(22) Filed: Aug. 14, 2002

(51) Int. Cl. H01R 13/60

(52) U.S. Cl. 439/529

(57) ABSTRACT

A personal care device support for supporting and powering a personal care deivce such as a hair dryer. A hair dryer support which removably connects to an electrical outlet to support a hair dryer comprising a base having a first opening and a second opening wherein the second opening is positioned below the first opening. The base further includes a beveled portion connecting the first opening to the second opening. The support further includes an extension attached to the base wherein the extension positions the base away from the electrical outlet. A plug is positioned within the extension opposite the base wherein the plug connects with the hair dryer and connects with the power source to power the hair dryer.

### BACKGROUND OF THE INVENTION

This invention relates to supporting a personal care device, and is particularly concerned with methods and apparatus for supporting a hair dryer while supplying power as a function thereof.

Electric hair dryers are a common personal care product used to style and blow dry hair after washing it. The electric hair dryers typically include a handle and an air-discharge nozzle extending away from the handle. Efficiently and conveniently handling the hair dryer is crucial to maintaining the preferred style and an organized schedule, in particular in the morning prior to leaving for work. As such, handling the hair dryer in an easy manner is extremely important. During operation, it is often necessary to put the hair dryer down to be able brush or style the hair. During such instances, users often turn the unit off, and then turn it back on again when blow-drying is to continue.

A problem with this method, however, is the continuous starting and stopping of the unit tends to shorten the life of components within the unit. Some users have simply left the unit running on a countertop while styling their hair, but the vibration of the motor can send the unit moving across the counter or sink. This movement poses a safety hazard, as the heated air may be directed against the user's body or against some object that can be damaged by excessive heat. Further, the hair dryer could fall into a sink filled with water and pose an electrical hazard. Additionally, some users place the hair dryer on some other item on the sink to contain the hair dryer. This placement, however, leads to a messy, unorganized condition.

A need, therefore, exists to accurately and easily support the hair dryer while the user is brushing or styling the hair. The solution, however, must be capable of allowing the hair dryer to stay “on” without the hair dryer moving across areas such as the sink. Accordingly, a need exists to power the hair dryer while its being supported. The solution, however, must provide a safe method of powering the hair dryer. Further, a need exists for the support to plug directly into a power source, wherein the solution, must also electrically connect the hair dryer to the support. Still further, a need exists for the user to manipulate the support for optional convenience and use of the support.

Supports presently available do not provide any flexibility for the user. For example, hotels often provide a hair dryer permanently attached to the power source. This device does not solve the current need as the user is limited to only using the hair dryer where the holder is located, typically in the bathroom wall. Accordingly, the user cannot use the hair dryer in another room. Also, this device typically shuts off the hair dryer each time it is put in the holder leading to a shorter operating life as previously mentioned.

Also, within the prior art, it has been known to support a hair dryer from some type of bracket assembly relative to a wall surface. However, these bracket assemblies require complex construction. Also, these bracket assemblies are not universal in connecting with different types of hair dryers.

Other types of supports relate to fixtures attached to the wall. These supports do not solve the current need as most users do not want a permanent fixture for a device that is only briefly used each day. Still other supports are directed to the hair dryer handle wherein the supports include a strap that wraps around the handle. This support only secures the dryer when the strap is extremely tight and if the strap has sufficient width in order to overcome the moment caused by the user in the movement of the dryer into the proper position. Movement, however, can loosen the dryer, which will cause it to sit in an awkward position or potentially fall from the support. Accordingly, these supports do not solve the current need. In addition, in some dryers the switches that control the heat, airflow and power are positioned on the front of the handle. If the strap wraps around the handle, this would potentially obstruct these switches from the user.

Thus, the current need requires a support that is convenient to use, simple in construction and includes a fastening device for rapid attachment and detachment to a power source while supporting a wide variety of hair dryers.

### SUMMARY OF THE INVENTION

The present invention provides for supporting a personal care device, in particular, a support which holds a hair dryer while supplying power to the hair dryer. To that end, the invention provides a device and method that efficiently and conveniently supports a hair dryer while allowing a user to style hair.

Described in the accompanying drawings and following text is a support that powers and holds a hair dryer in an easy and convenient method wherein this configuration leads to improved styling. Thus, the present invention disclosed herein provides a hair dryer support which overcomes many of the inadequacies of supports known in the art.

In an embodiment, the present invention provides a base which has openings and a member to surround the openings. The hair dryer is inserted into the openings wherein the openings are configured to receive the hair dryer. In order to distance the base, and subsequently the hair dryer, away from a room wall, an extension is placed between the base and the wall. Additionally, the plug is associated with the extension wherein the plug connects to a power source typically located in the room wall. Thus, during use, the extension is connected to the power source via the plug. Since the base is positioned away from the power source, the hair dryer can be conveniently inserted into the base while still being powered by the plug.

An advantage of the present invention is to provide a support that efficiently and conveniently supports a hair dryer while the user is brushing or styling the hair.

Another advantage of the present invention is to allow the hair dryer to remain powered while being supported.

Another advantage of the present invention is directly plug the support into a power source.

### BRIEF DESCRIPTION OF THE DRAWINGS

FIG. 1 is a side elevational view of a support embodying the principles of the present invention.

FIG. 2 is a front view of the dryer in FIG. 1 according to the present invention.

FIG. 3 is a front view of FIG. 2 shown without the hair dryer.

FIG. 4 is a perspective view of an another embodiment embodying principles of the invention.

FIG. 5 is a perspective view of FIG. 4 with the embodiment shown connected to a power source.

FIG. 6 is a side elevational view of another embodiment embodying principles of the invention.

FIG. 7 is a front view of FIG. 6 embodying principles of the invention.

FIG. 8 is a flow chart of a method utilized in the present invention.

### DESCRIPTION OF THE PREFERRED EMBODIMENTS

As discussed above, the present invention provides structures and other accommodations to support a personal care device such as a hair dryer. The present invention efficiently and conveniently supports the hair dryer while supplying power.

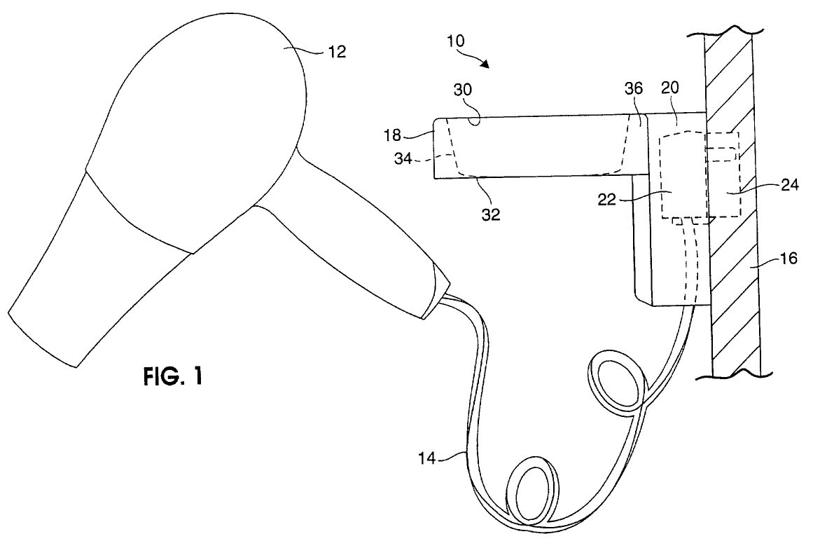

FIG. 1 illustrates a side elevational view of an exemplary support 10 to hold a personal care device dryer 12. In FIG. 1 there is generally shown the personal care device 12 as a hair dryer. As shown in FIG. 1, the hair dryer 12 is separated from the support 10 while still being connected to the support 10 via a cord 14. The support 10, in turn, is connectable to a power source 24 typically associated with a wall 16.

The support 10 comprises a base 18, an extension 20 and a plug 22 typically associated with the extension 20. In order to attach and detach from the wall 16, the plug 22 connects with the power source 24 such as a wall socket as commonly known. Thus, the cord 14 extends within the extension 20 to connect to the plug 22 and the hair dryer 12. Accordingly, the hair dryer 12 is powered by the power source 24 through the support 10.

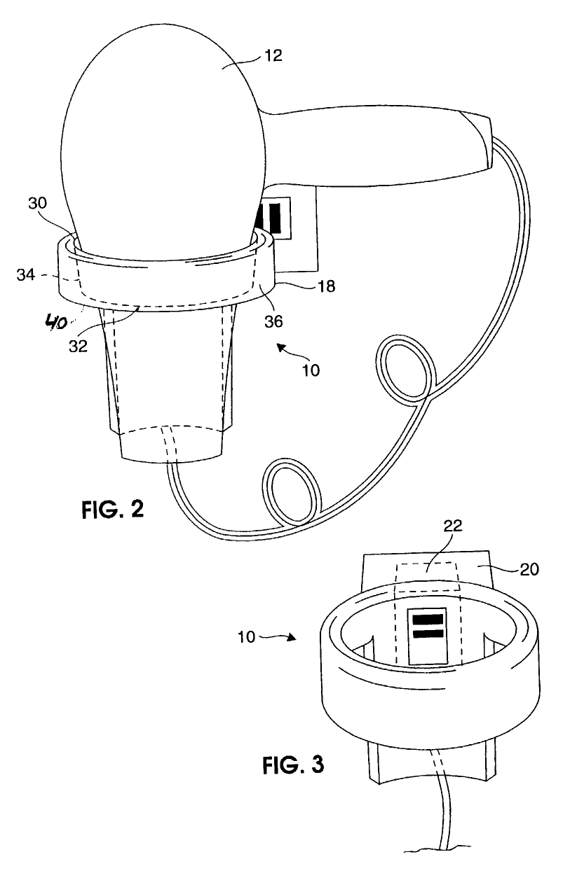

Turning to FIGS. 2 and 3, base 18 is configured to hold the hair dryer 12. The base 18 includes a first opening 30, a second opening 32 and a portion 34 connecting the first opening 30 and the second opening 32. The base 18 further includes a member 36 which surrounds the first opening 30 and the second opening 32. As shown, the first opening 30 and the second opening 32 are round wherein the first opening 30 is larger than the second opening 32. The first opening 30 and the second opening 32 may, however, include other shapes, such as but not limited, to oval or square. Since the first opening 30 is larger than the second opening 32, the first opening 30 is positioned above the second opening 32 in order to support the hair dryer 12 in a vertical position as shown in FIG. 2.

Due to the positioning of the first opening 30 and the second opening 32, the portion 34 connects the first opening 30 with the second opening 32. Accordingly, as shown in FIG. 2, the portion 34 is bevel shaped from the first opening 30 to the second opening 32. In the embodiment shown, the second opening 32 is positioned within the member 36 resulting in the portion 34 being bevel shaped to form a cone shape to receive the hair dryer 12. The second opening 32, however, may also be positioned at an end 40 of the member 36 to accommodate different styles and lengths of hair dryers 12. In this configuration, the portion 34 is typically straight shaped to connect the first opening 30 with the second opening 32. Alternatively, the portion 34 may be angled shaped to connect the first opening 30 and the second opening 32.

Returning to FIG. 1, the extension 20 connects to and extends away from the member 36. By extending the extension 20 away from the member 36, the base 18 can be positioned off the wall 16 allowing clearance for the hair dryer 12 to be properly supported. Accordingly, the extension 20 extends planarly away from the member 36 toward the wall 16. The extension 20 further extends perpendicularly away from the member 36 to provide proper leverage against the wall 16. Additionally, the extension 20 perpendicularly extends to enclose a portion of the cord 14 within the extension 20.

Additionally, as shown in FIGS. 1 and 3, the plug 22 is positioned within the extension 20. Further, since the hair dryer 12 is an electrical device used near water, the plug 22 includes an ALCI adapter. Thus, the plug/ALCI adapter 22 is housed within the enclosure 20 while connecting to the power source 24 to power the hair dryer 12. FIG. 3 shows the support 10 with the hair dryer 12 removed to show more clearly the plug 22 associated with the extension 20.

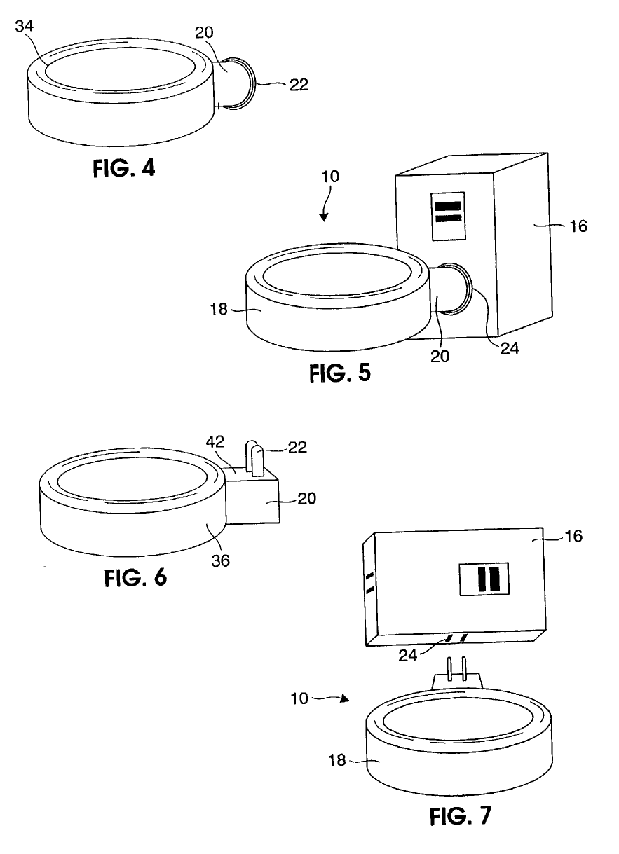

Turning to FIGS. 4 and 5, another embodiment of the present invention is shown. As shown, the extension 20 extends away from the member 36 toward the wall 16 (shown in FIG. 5) in an elongated form. Accordingly, the plug 22 is positioned at an end of the extension 20. Additionally, the extension 20 as shown, is tubular shaped but may include other shapes such as rectangular. As shown in FIG. 5, the support 10 connected to the power source 24. Still further in this embodiment, the extension 20 may be adjustable to provide different spacing distances between the base 18 and the room wall 16. As such, the base 18 may reciprocate with respect to the wall 16 to accommodate different configuration of hair dryers 12.

Turning to FIGS. 6 and 7, another embodiment of the present invention is shown.

As shown, the extension 20 perpendicularly extends away from the member 36 toward the wall 16 in an elongated form. Accordingly, the plug 22 is positioned at an end of the extension 20. The plug 22, however, perpendicularly extends out of a surface 42 such as the top or bottom of the extension 20. With this positioning, the plug 22 may connect to the power source 24 positioned in a different configuration such as the side. Additionally as shown, the extension 20 is rectangular shaped but may include other shapes such as tubular. As shown in FIG. 7, the support 10 is connected to the power source 24. Still further in this embodiment, the extension 20 maybe adjustable to provide different spacing distances between the base 18 and the wall 16. As such, the base 18 may reciprocate with respect to the wall 16 to accommodate different configuration of hair dryers 12.

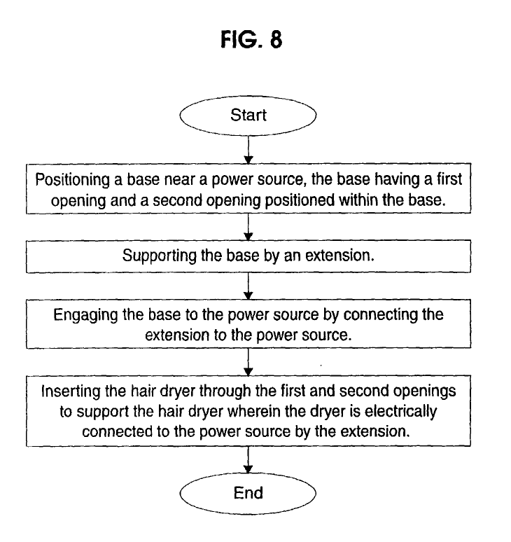

In use, the present invention provides a unique method of supporting a hair dryer 12. In particular, the present invention provides a unique method supporting a hair dryer 12 while still providing power to the hair dryer 12. Turning to FIGS. 1-3 and 8, an exemplary method of the present invention is shown. In use, the support 10 holds the hair dryer 12 at an optimal position for the user. The base 18, having the first opening 30 and the second opening 32, is positioned near the power source 24 via the extension 20. The base 18 is capable of adjusting to the proper spacing with respect to the power source 24 by extending or shortening the extension 20.

Next, the base 18 is connected to the power source 24 via the plug 22 which is typically positioned within the extension 20. In turn, the cord 14 connects the hair dryer 12 to the plug 22 as shown in FIG. 1. After blow-drying, the hair dryer 12 is inserted into the base 18 via the first opening 30 and the second opening 32. Since the first opening 30 is larger than the second opening 32, the hair dryer 12 is properly directed into the base 18 for a tight fit as shown in FIG. 3. Accordingly, the portion 34 is configured to direct the hair dryer 12 toward the second opening 32. The hair dryer 12 may then be turned “off: when positioned in the base 18 and further turned “on” when taken out of the base 18.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1. An personal care device support, comprising:
a base, the base having a first opening, a second opening and a portion connecting the first opening and the second opening, the base further including a member which surrounds the first opening and the second opening;
an extension, the extension being connected to the member and extending away from the member; and
a plug, the plug being positioned in the extension wherein the plug connects with a power source.

2. The personal care device support of claim 1, wherein the first opening is larger than the second opening.

3. The personal care device support of claim 1, wherein the first opening is positioned above the second opening.

4. The personal care device support of claim 1, wherein the first opening and the second opening are round.

5. The personal care device support of claim 1, wherein the second opening is positioned within the member.

6. The personal care device support of claim 1, wherein the second opening is positioned at an end of the member.

7. The personal care device support of claim 1, wherein the portion is bevel shaped.

8. The personal care device support of claim 7, wherein the portion bevels from the first opening toward the second opening.

9. The personal care device support of claim 1, wherein the extension is telescopic.

10. The personal care device support of claim 1, wherein the extension extends planarly away from the member.

11. The personal care device support of claim 1, wherein the extension extends perpendicularly away from the member.

12. The personal care device support of claim 1, wherein the extension is tubular shaped.

13. The personal care device support of claim 1, wherein the power source is an electrical outlet.

14. The personal care device support of claim 1, wherein the plug removably connects to the power source.

15. The personal care device support of claim 1, further including a cord connected to the plug.

16. The personal care device support of claim 15, wherein the cord further connects to a personal care device.

17. The personal care device support of claim 16, wherein the personal care device is a hair dryer.

18. A hair dryer support which removably connects to an electrical outlet to support a hair dryer, comprising:
a base, the base including a first opening and a second opening wherein the second opening is positioned below the first opening, the base further including a beveled portion connecting the first opening to the second opening wherein the base supports the hair dryer;
an extension, the extension being attached to the base wherein the extension positions the base away from the electrical outlet;
a plug, the plug being positioned within the extension opposite the base wherein the plug connects with the electrical outlet; and
an electrical cord which connects to the plug and the hair dryer.

19. The hair dryer support of claim 18, wherein the base further includes a member to surround the first opening and the second opening.

20. The hair dryer support of claim 18, wherein the first opening is larger than the second opening.

21. The hair dryer support of claim 18, wherein the second opening is positioned within the wall.

22. The hair dryer support of claim 18, wherein portion bevels from the first opening toward the second opening.

23. The hair dryer support of claim 18, wherein the extension extends planarly away from the wall.

25. A method of supporting a hair dryer, comprising:
positioning a base near a power source, the base having a first opening and a second opening positioned within the base;
supporting the base by an extension;
engaging the base to the power source by connecting the extension to the power source;
inserting the hair dryer through the first and second openings to support the hair dryer wherein the hair dryer is electrically connected to the power source by the extension.

26. The method according to claim 25, further comprising extending the position of the base from the power source by movement of the extension.

27. The method according to claim 25, further comprising positioning a plug within the extension.

28. The method according to claim 27, further comprising connecting the hair dryer to the plug by a cord.

29. The method according to claim 25, further comprising beveling the first opening toward the second opening to provide support for the hair dryer.

30. The method according to claim 25, further comprising turning the hair dryer off when the hair dryer is inserted through the base to support the hair dryer.

31. The method according to claim 25, further comprising turning the hair dryer “on” when the hair dryer is removed from the base.
